(19) United States
(12) Patent Application Publication
(10) Pub. No.: US 2007/0265097 A1
(43) Pub. Date: Nov. 15, 2007

(54) Method and Device for Context Driven Content Gaming

(76) Inventor: Kai Havukainen, Lempaala (FI)

Correspondence Address: Hollingsworth & Funk, 8009 34th Avenue South, Suite 125, Minneapolis, MN, 55425, US

(21) Appl. No.: 10/572,715

(22) PCT Filed: Sep. 24, 2003
(86) PCT No.: PCT/IB03/04140

§ 371 Date: Mar. 2, 2007

(51) Int. Cl. G06F 19/00

(52) U.S. Cl. 463/43

(57) ABSTRACT

The present invention relates to games on electronic game devices. More specifically the present invention relates to a method and a device for generating game control data related data. The present invention is provided to execute a game in relation to present or selected external circumstances that can be perceived by a player. The method of the present invention is based on accessing context data such as e.g. a piece of music, and generating game control data on the basis of said accessed context data. The game control data can be used to control the execution of the game, which can be in turn perceived by the player as providing more realism in gaming.

The present invention relates to games on electronic game devices. More specifically the present invention relates to game devices, which are additionally provided with a music player device. The present invention further relates to mobile communication devices that are game and music player enabled. The present invention further relates to a method to carry out a game in such a device.

Presently, there are many different electronic games available on the market, which are provided with the ability to play background music. Presently, a user can select different provided background music tunes for a given game to prevent that a user gets bored of hearing always the same tune or theme. The acoustic output provided with conventional games is usually composed from a background music and game specific audio output for supporting the game interaction (i.e. sound effects). Conventionally, a user can play a game with a kind of acoustic support like sound feedback or acoustic input confirmation. The acoustic feedback has a significant disadvantage, as the sound effects usually comprise only a very reduced set of sounds which are usually repeated very often resulting in tiredness of the ear resulting in headache. A usual approach to game music is that difficult game levels have more aggressive music than easier ones, and speeding up the game also causes an increase of the speed of the background music.

Conventional games using audio output are e.g. described in the U.S. Pat. No. 6,561,908 B1, which discloses a gaming device with a metronome system. The metronome system reads game state data on ticks determined by a check-back rate, and causes sound file changes to occur at any time a click occurs. The metronome system enables a plurality of sound recordings to be interfaced on beat or otherwise. The metronome system provides gaming devices with enhanced sound and music capabilities.

Another document relating to the state of the art is WO 01/83055 A2 ‘Real time incorporation of personalized audio into video game’. This document provides a computer method and system for incorporating user-personalized music and/or sound into a video game. It also relates to encoded tag text files that identify a user-personalized sound file to be played back at a specific point in the execution of a program.

All the above approaches for combining music and game play are suitable for the use with electronic games and have provided nearly all combinations of games and music. In the state of the art a user can hear his favorite background music when playing his home stereo in the background and having only the sound effect activated. It is even possible to synchronize the playback of a song with the timing of a game. Thus the state of the art seems to cover all conceivable and desirable combinations of games and music.

Hence, it is desirable to have a non-conceivable combination of electronic games and music. It is also desirable to overcome present problems, as the state of the art seems to not provide all possibilities to combine a game and background music.

It is desirable to have a new combination of games and music. It is also desirable to have an electronic game device, which is capable of providing a new game experience in relation with e.g. background music or other context data.

It is further desirable to improve the game experience of a user with an improved game device or module or with an improved game execution method.

According to a first aspect of the present invention a method for controlling an electronic game in accordance with context related data is provided. The method comprises accessing of context data and generating game control data on the basis of said accessed context data. The expression “context data” is used to underline that these data are not game internal data provided within a game software. By accessing of context data, data such as user-selected background music or a user-selected picture can be used to individualize an electronic game. By generating game control data on the basis of said accessed context data, game parameters can be used to control the execution of the game.

In an example embodiment of the present invention the method further comprises executing said game according to said generated game control data. In this example embodiment the present invention may be described by making the progress of an electronic game conditional upon external influences. It may be noted that the expression ‘external influence’ does not refer to user input to control the game.

In another example embodiment of the present invention said accessing of context data further comprises the processing of context data. By processing and evaluating said context data, e.g. a data format can be adapted to a preferred game control feature. If e.g. the external data is in a format not fitting a special game control feature, a respective translation algorithm may adapt it. The processing can also be used to derive e.g. dynamic data (timing) from a static data set (e.g. a picture).

The processing of context data can also include the generation of context data on the basis of a generation algorithm. In this case the generation algorithm may be regarded as ‘context data’, and the generated (and processed) data as game control data. In the case of music context data may be generated by a composing algorithm, by producing a music data stream, which is in turn used as a basis for generating the game control data. It is also possible to use a control data generation algorithm or default control data to provide a continuous data stream to the game application. Thereby it can be prevented that the game ‘freezes’ i.e. the game execution is interrupted in case that no context data are available. So in case of music the game is in a silent passage or in the small pauses between two pieces of music the gam may be driven by a default set of game control parameters.

In yet another example embodiment of the present invention said processing of context data is performed in relation to actual game data. Thereby a feedback feature can be implemented to prevent that game parameters are overridden exceedingly. It is envisaged for example to provide the game control data within user-defined or game-defined thresholds. By using such thresholds the game characteristics can be forced into restrictions to guarantee that higher levels of a game are actually more difficult than the first levels independent of the actually selected context data. Another application can reside in that the same context data result in different effects in dependence of the actual content i.e. the actual stage or virtual environment. For example in a race simulation a ‘big block’ engine can be tied to the low-frequency part of a user selectable background music while the performance of an ‘Italian sports car’ depends on the high frequencies the background music.

In just another example embodiment said context data comprise sensor data. By using a sensor such as a temperature sensor, an acceleration sensor, a light sensor, a sound sensor or the like, the realism of an electronic game can be improved significantly.

The sensor can be a sound sensor for ambient sound (e.g. a microphone), so a user can play synchronized with ambient sounds. This enable a user to play synchronized to e.g. a live concert, or synchronized to the typical sounds e.g. a railroad vehicle produces. In case of a microphone, an active acoustic feedback suppression to prevent that sound effects produced by the game may control the game in a feedback loop. In case of a microphone, an acoustic feedback of sound effects produces by the game to control the game may even be desirable.

For example in a game with a woody virtual environment birds may fly off, or predators are attracted upon detecting an ambient noise or sound.

The sensor can comprise motion sensors, wherein the game plays differently if you are walking, running, sitting, or on a train or other vehicle. The sensor can comprise an acceleration sensor wherein the game plays differently if you are shaking, walking, running, sitting, or on a train or other vehicle or simply holding the device at different angles.

A sensor may also be used to monitor the heart beat frequency, to control the game in limits that the hart beat stays within desired (and probably healthy) limits. A sensor may also be used to monitor the activity of the brain, to control the game in limits that the e.g. epileptic fits can controllably be prevented, so that the encephalogram data may be used to shut off the game when a risk of epileptic fits for the user is detected.

A sensor may even analyze the input of the player and loop it. Such a feature may be implemented as a ‘self-adjusting’ difficulty control. This use case may be implemented with an ‘anti-wind-up-algorithm’ to prevent that a user hammering on the keys of a controller increases/decreases a game parameter exceedingly.

In yet another example embodiment said context data comprise music data. Music data can easily be analyzed for tempo, loudness, frequency distribution, tone figures (i.e. note sequences) and the like. Music analyzing tools are well known to the state of the art, as visual implementations for equalizer displays. Thus a piece of music can provide different channels with different event structures. For example in a MIDI (music instrument digital interface) format a score library can be used to control different game elements according to the tone sequences for each of the instruments, wherein each game element can be related to the tone sequence of at least one instrument.

To control e.g. the speed of a game element on basis of a sheet of music can be implemented by coupling the clock of the game to the number of notes in a time.

An external influence can be implemented as music replayed in the background. The background music can even be replayed from the same electronic device the game is executed on. ‘External’ in this context refers to not part of the game execution software. It is also possible to receive music via a built-in microphone. It is also possible to use a line-in connector to transfer analogue or digital music data from an external source. It is also possible to use a radio connection to transfer analogue or digital music data from an external source, e.g. via Bluetooth or from am radio broadcast station.

In yet another example embodiment said context data comprise visual data. Visual data can comprise picture files (JPEG, GIF, etc.), logos, animations (Flash, GIF, etc.) and video sequences (MPEG, AVI, DVX, etc.) and the like.

Picture files can be used to generate a dynamic data stream e.g. by defining, determining picture properties along a path and using the changes in said properties to control an electronic game. A path trough a two dimensional picture can be defined for example on basis of a path of an virtual game landscape like a roadmap in case of a car race, or on basis of any other pattern superimposed on said picture. The picture properties (e.g. brightness or any of the color intensities or their derivatives) along said path can represent e.g. curves or functions. These curves can be related to a game parameter such as time. It is e.g. in case of a racing track possible to use the different color intensities to define different road conditions such as, e.g. puddles, mud, track, asphalt, and bumps of a racing track for a rally game. In the simplest caste a picture can be scanned in 1, 2 or more tracks to generate a desired number of curves to control a desired number of game parameters.

It is also possible to use a color saturation of a picture superimposed on a virtual landscape as a value for an ‘event density’. The possibilities for the implementation are limited only by the fantasy of the developer of the respective game or content data control module.

Animations may not provide a very ideal database for the generation of a game control signals, as e.g. the amount of data in a fast repeating GIF (Graphics Interchange Format, a graphic file type) may comprise to few different parameters for a improved and game play.

Video sequences provide an abundance of different data streams, which are time variable. To visualize the nearly unlimited amount of data streams in a single video clip it is noted that each pixel of a video stream can provide a multi-dimensional (e.g. RGB Red Green Blue) data signal. When connected with histogram, music or other data nearly an arbitrary amount of different game control characteristics can be generated.

It is also possible to generate textures such as clouds, waves or plants from a video stream. Another possibility resides in that histogram data of pictures and videos can be used to derive game control data.

In yet another additional example embodiment said context data are used to control the timing of the electronic game. For example in a ‘Tetris’ game environment the beat can control the speed of an application, and variation in the timing can be derived from changes of the center frequency of the selected background music. It is also possible to drop a new block each second, third, fourth or other multiple of a note. In this case it may be advantageous to adapt the falling speed of the blocks to an actual speed of the music. In this scenario the most intuitive algorithm for a user/player should be implemented. Analogously, the same principles can also be applied to any kind of game wherein the speed of a game element is not directly controlled by user input. For example in ‘taxi’ type games the speed of other road users may be music related.

In another example embodiment said context data are used to control the events in said electronic game. It is possible to relate the number of obstructions or the number of support in a game to a received context data. For example in case of an adventure game the landscape characteristics may be related to the color value of a context picture. Another possible implementation can reside in a music dependency wherein at each pianissimo passage of a background tune induces that no fast or virtually dangerous events are to be expected.

In yet another example embodiment said context data are used to control actions in said electronic game. For example in an underwater environment the background underwater plants may sway in the rhythm of the background music. It is also possible to use context data to control the weapon usage of a virtual enemy in a fight or war game. For example a battleship may fire each of its batteries/cannons depending on a single tone in a background song. In such a war simulation, the weapon use combined with the simulated muzzle flashes may appear as a kind of clavilux. In this case the score for all instruments may directly be uses as a weapon control signal for a whole fleet, wherein each instrument is related to a vessel or a vessel type and each battery type is related to a certain tone height.

Similarly, in games where a great number of individual elements are controlled by a user or a game each of said elements can be related to a certain tone of a certain instrument. The tone length can be related to a certain action, for example a whole note may represent a trip, a half note may represent a long jump an a quarter note may represent a short jump or a short speed up in a motion. Thereby the behavior of a great number of individuals may appear more lifelike.

According to another aspect of the present invention, a computer program product downloadable from a server for carrying out the method of the preceding description is provided, which comprises program code means for performing all of the steps of the preceding methods when said program is run on a computer or a network device.

According to yet another aspect of the invention, a computer program product is provided comprising program code means stored on a computer readable medium for carrying out the methods of the preceding description, when said program product is run on a computer or a network device.

According to yet another aspect of the present invention, an analyzer module is provided. The analyzer module comprises an interface that is connectable to a data source for receiving context data, an interface that is connectable to a game execution processor for outputting game content control data, and a processing unit for generating said game content control data in accordance with said received context data.

The analyzer module is intended to be connected to a gaming device and to a context data source to control the execution of a game on said gaming device in accordance with said context data. It is also possible to use the analyzer module to pre-analyze a set of context data, and store said analyzed data to be retrieved for running an electronic game. The pre-analyzed data may be retrieved or used in a time-synchronized manner, so that the actions on the screen (i.e. the game content) are synchronized with played back context data.

In an example embodiment of the present invention said analyzer module is implemented in a synthesizer module. By implementing the analyzer module directly in a synthesizer module, the music can be analyzed directly at the place the music is generated. It should be easy to implement a synthesizer module with additional output interfaces to provide music specific data that can be used to control the execution of an electronic game.

Similarly, the analyzer module can also be implemented in a video player module, or in an audio synthesizer module of a video player module.

According to another aspect of the present invention an electronic gaming device is provided that comprises first and second processing units and a data source for context data. Said first processing unit is provided for executing an electronic game in conventional manner. Said data source for context data, is provided for accessing external data as set forth in the preceding description of the method of the present invention.

Said second processing unit is connected to said data source and to said first processing unit. Said second processing unit is connected to said data source for receiving context data. Said second processing unit is provided for generating game content control data on basis of said context data. The second processing unit is connected to said first processing unit for transferring generated game control data to said first processing unit. In said electronic game device said first processing unit is configured to execute an electronic game according to said received game control data.

Such an electronic device can be configured to relate the execution of an electronic game to external data such as a data set, a replayed data stream or environmental data. To enable gaming with the present gaming device the gaming device can further comprise an interface for connecting to a user interface e.g. a controller or display connector. The gaming device can further comprise a user interface. The user interface can comprise user input and user output interfaces such as keys, joysticks, touch-screens, displays monitors and the like.

In an example embodiment of the present invention said electronic gaming device further comprises a memory for storing of context data and/or game control data. The nature or the type of context data is not defined from the beginning, depending on the respective implementation, the storage may be implemented as an electronic, a magnetic or an optic memory device.

The electronic device may comprise an interchangeable memory device connected via a respective memory interface. The context data can be e.g. music data, the storage for the context data may be implemented as a compact disc (CD) and a compact disc player would represent the interface to the CD. The interchangeable memory device can be any kind of interchangeable memory device available on the market. The storage may also be used to store game control data in case that the context data can be pre-analyzed before the game is started.

In another example embodiment of the present invention said connection between said first and second processing units is a two-way connection. By using a two-way connection the game can influence the actually used context data analyzing algorithms. Thereby, the game may control the actually used algorithms to guarantee that the game control data are actually adapted to the used game situation. The game engine may provide e.g. limits or threshold values for a set of game control parameter to guarantee that the game difficulty or playability is within predetermined limits.

In yet another example embodiment of the present invention said electronic gaming device further comprises at least one sensor connected to said second processing unit. The device can also comprise a sensor evaluation circuit, connected to said sensor, to provide e.g. digitized, standardized or normalized sensor data.

The sensor can be any kind of sensor. The sensor can be a temperature sensor for sensing an ambient temperature. This sensor can be used to adapt the game environment to an ambient temperature, e.g. change the road conditions in a rally game to a sensed temperature. The sensor can be a body temperature sensor. It is also possible to implement heartbeat, an eye movement, an encephalitic, a supply of blood or a blood circulation sensor to the controller of a game to slow down the game execution in case one of said parameters reach or approach a critical values. It is also possible to provide the game with a ‘forced break’ algorithm, i.e. the game saves a present game situation and interrupts the game for a predetermined time interval e.g. for 10 minutes each hour, to prevent the ‘nub-thumb’ syndrome.

The sensor can be an ambient sound sensor to couple the game play to ambient noises. The sensor can be implemented as a motion and/or acceleration sensor to execute the game differently if you are running, walking, sitting, or are on a train a subway or a bus.

It is also possible to implement the sensor as a sun directional sensor to simulate the illumination on a display in relation to the actual light conditions. This can be implemented straightforward, as e.g. display information in ‘shady’ areas ma be suppressed, directly influencing the perception of the user and thus the execution of the electronic game.

In another example embodiment of the present invention said electronic gaming device comprises an interface for accessing sound and/or music data. The interface can be implemented e.g. as a radio broadcast receiver. The interface can be implemented e.g. as a sampled audio player for playing e.g. WAV-files, MP3-files, AAC—(Advanced Audio Coding, an MPEG-2 audio codec) files, etc. The interface can be implemented e.g. as a synthetic audio for playing SP-MIDI—(Scalable Polyphony MIDI), General MIDI-, XMF-(eXtensible Music Format) files etc. The interface can be implemented e.g. a microphone, or a ‘line in’ connector. The interface can be implemented e.g. a radio interface such as Bluetooth or W-LAN (wireless local area network) for receiving audio files or an audio data stream.

In yet another example embodiment of the present invention said electronic gaming device further comprises an interface for accessing visual data. The interface can be implemented e.g. as radio interface for receiving pictures (JPEG, GIF, etc.) animations (Flash, GIF, etc.) or video clips (MPEG, AVI, etc.) in form of files or as a continuous data stream. The interface may also be implemented as a television receiver.

In another example embodiment of the present invention said electronic gaming device further comprises a limiting device connected to said first processing unit for limiting the execution said electronic game according to said received game control data. The limiting device can prevent for example that the context data can overrun or override the game execution and make the game unplayable. The limiting device may be provided with thresholds to limit e.g. the number of newly generated enemies to the maximal offensive or defensive capabilities of the game. Thus in fast and loud music passages the game may not become unplayable because of too many game actions. The limiting device can also be provided with a threshold to grant a minimum difficulty for the game execution. Thus in slow and quiet music passages or in the pause between two pieces of music the game may not ‘freeze’, i.e. seem to stop as all music dependent actions and animations are stopped because of a lacking input signal.

The limiting device may be implemented in the game or in the context driven content engine. The limiting device may be implemented as a transient storage, repeating a number of time units before a context signal has stopped, or fallen below a threshold level. The limiting device may be implemented as a device activating a default game control data set that is activated if a context signal has stopped, or fallen below a threshold level. The limiting device can be connected to the first and/or to the second processing unit. The limiting device can also provide only a context driven mode flag to the first processing unit to activate and/or deactivate the context driven content mode.

In another additional example embodiment of the present invention said electronic gaming device is a mobile gaming device. By mobilizing said game device, the application of sensors is especially beneficial, as the environmental conditions compared to a home application can provide a wider variety of values. The application of illumination-, temperature-, movement-, acceleration- and the like sensors can access a wider variation of values in an outdoor environment than in a relatively static indoor environment with controlled climatic and light conditions.

In another additional example embodiment of the present invention said electronic gaming further comprises a cellular telephone. It is also possible to implement said gaming device in a PDA (personal digital assistant). A telephone with computation and a game execution and media playback capability can be implemented to fulfill all requirements of a modern human in regard of communication, time management, computation and defense of boredom.

In the following, the invention will be described in detail by referring to the enclosed drawings in which:

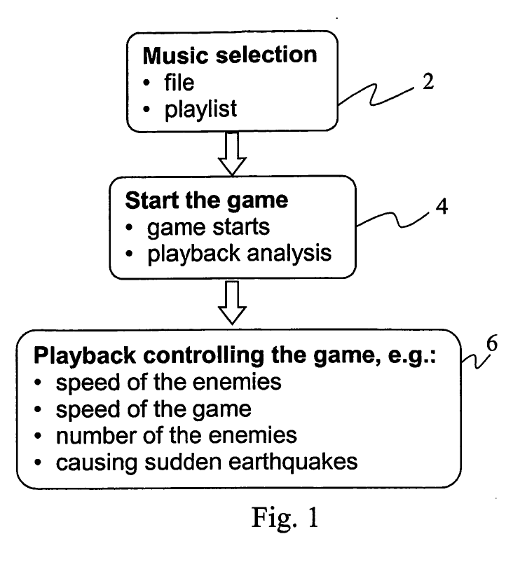

FIG. 1 is a flowchart of a method for executing an electronic game in dependence of context related data according to one aspect of the present invention,

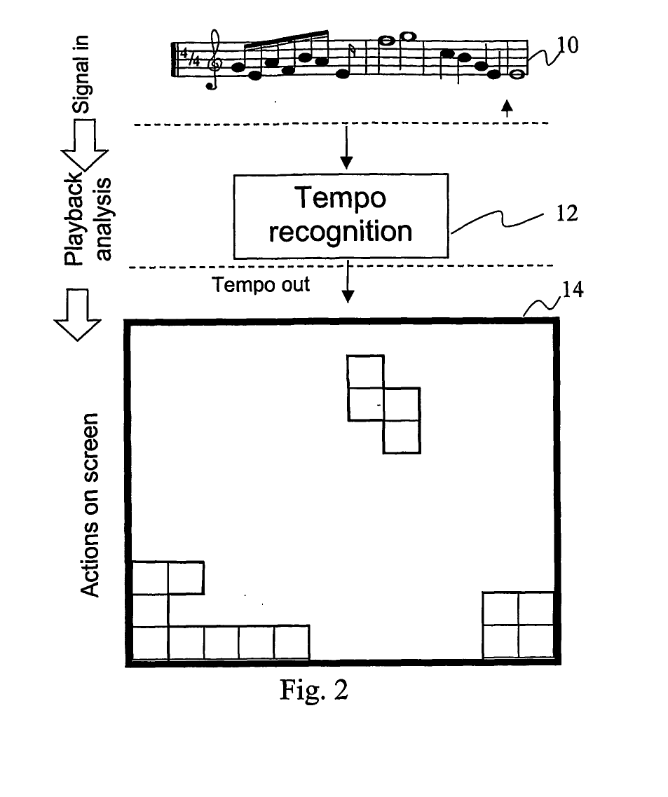

FIG. 2 is an example of an implementation of a music based tempo control for an electronic game application according to the present invention,

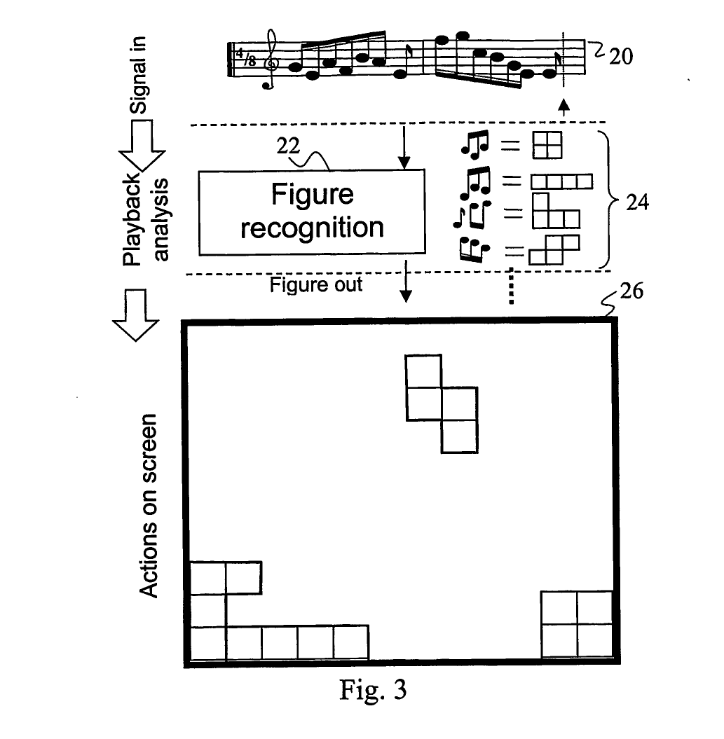

FIG. 3 is an example of an implementation of a music based game action control for an electronic game application according to another aspect of the present invention,

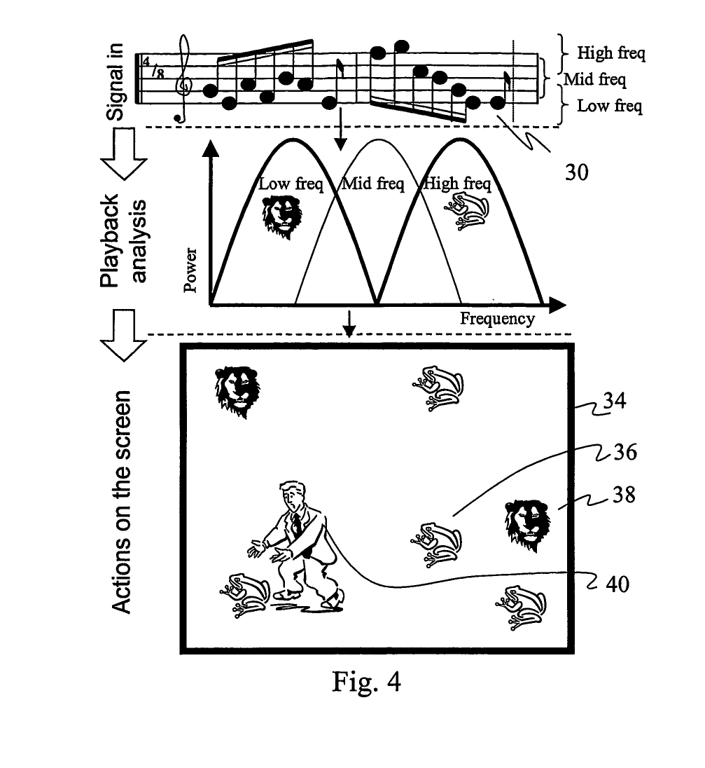

FIG. 4 is a further example of an implementation of a music based game action control for an electronic game application according to an aspect of the present invention,

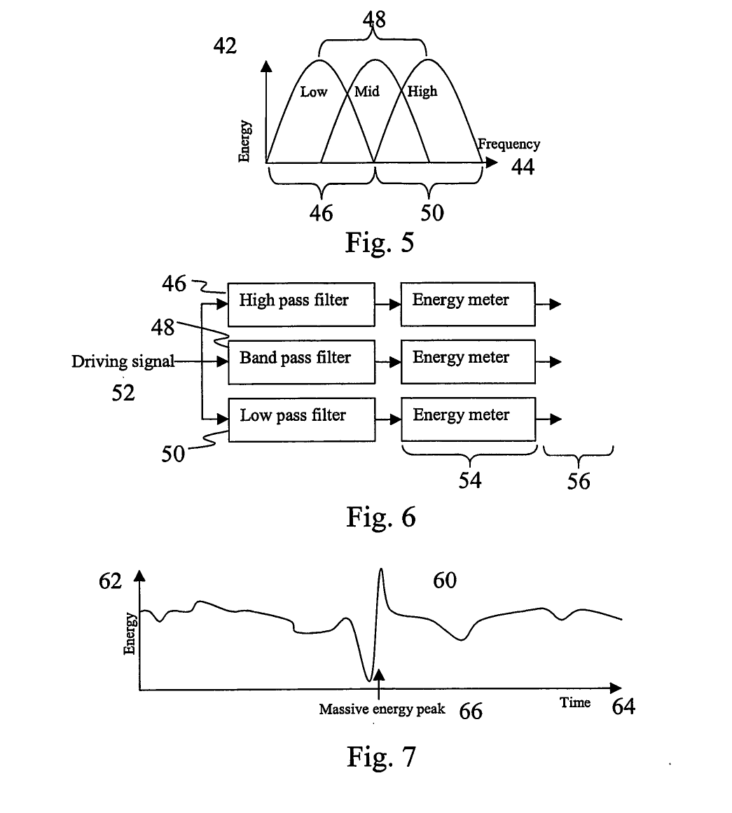

FIG. 5 is a detailed description of a filter implementation for the game application of FIG. 4,

FIG. 6 is a detailed description of an analyzer circuit implementation of the filter of FIG. 5,

FIG. 7 represents a possible output at one of the channels of the filter circuit of FIG. 6,

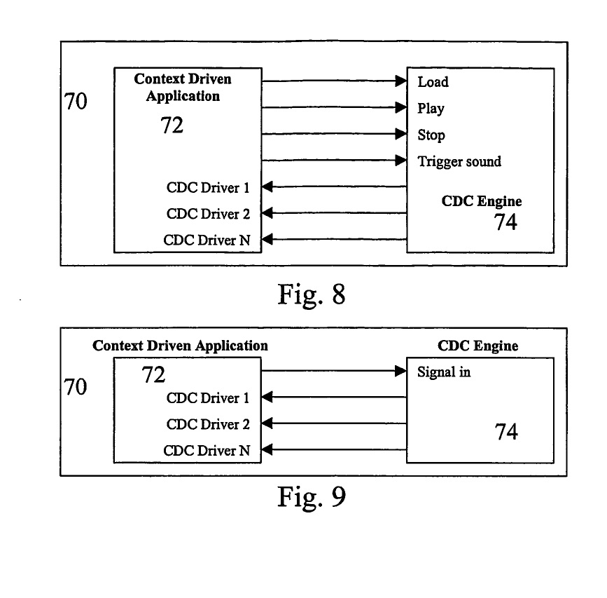

FIG. 8 schematically depicts one implementation of context driven content engine, and

FIG. 9 schematically depicts another implementation of context driven content engine.

FIG. 1 depicts a flowchart of a method for executing a virtual game in dependence of context data according to one embodiment of the present invention. The depicted embodiment relates to pre-stored context data, here music. The method starts with the selection 2 of background music by selecting a music file of a pre-generated music playlist.

The invention can proceed with starting 4 an electronic game and a music playback and playback analysis. In the following, the game parameters are controlled 6 according to said playback analysis. Thus this embodiment of the present invention enables musically controlled electronic games. For example the game difficulty level can be controlled by the background music, and/or be controlled by a respective selection by the player. The music may be provided as MIDI or sampled audio, such as MP3 in single files or in playlists. The control parameters can be extracted from parameters such as e.g. frequency bands, signal energy changes, tempo or tone sequences.

The method is also applicable to other media or data files, such as video clips and pictures, or to external sensor signals.

When using the game a the challenge for a players resides not more just in clearing/solving the final level in an electronic game but in solving the final level of the game with Queen's ‘The show must go on’ or with Metallica's ‘Enter Sandman’. Another advantageous effect resides in that the user can hear his favorite music when playing his favorite game.

To illustrate how the driver parameter could be extracted from the driver format, some features of sampled and synthetic audio are described next that could be used as driver parameters. More advanced feature extraction methods can be applied, but here maybe the most intuitive of them are explained.

FIG. 2 is an example of an implementation of a music based tempo control for an electronic game application according to the present invention. FIG. 2 is based on the well-known ‘Tetris™’ game, so that the principles of the game are estimated to be known to the artisan. Tetris is commercially available for nearly every game console and computer device. In FIG. 2 the idea to control the falling speed of the objects by the tempo of the playback music. This embodiment can be implemented e.g. by analyzing a received music signal 10. The music signal can be received from an external music source such as e.g. a line-in connector.

The received music signal is then tempo-analyzed 12. This may be preformed e.g. by determining the number of notes per time, and controlling the falling speed of a next block or object accordingly. The received music signal can also be tempo-analyzed by pre-analyzing the external signal, and dropping a block each 3^{rd} or 4^{th} note. In this case the pre-analysis can provide a synchronicity between the game and the background music. The falling speed can be determined by the time that a group of notes needs to be played.

In both said cases, the number of notes or times may be pre-selectable by a user to influence the basic difficulty of the game.

The timing analysis puts out a ‘falling speed’ signal to control 14 the difficulty of the game in accordance with actually played game by controlling the falling speed of an object. It is possible to pre-calculate the falling speed of an object so that the next object will be released in a synchronized manner. It is also possible to control the falling speed in a more direct way so that at each note the falling block is moved one step (or more sub-steps) down.

FIG. 3 is another embodiment of a music-based game action control for an electronic game application according to the present invention. Similar to FIG. 2, a music signal 20 is used to control parameters of the electronic game ‘Tetris’. Here the game control engine is a ‘note figure’ recognition engine 22. The note figure recognition engine 22 relates each succession of notes to a respective block figure. The relation rules 24 can be selected nearly arbitrarily.

For example a sequence of three notes in succession that represent a valley (i.e. a decrease and an increase of the tone height) represents a ‘square block’. For example a sequence of three notes in succession that represent a tip (i.e. an increase and a decrease of the tone height) represents a ‘line block’. For example a sequence of three notes in succession that represent an increase (i.e. two increases of the tone height) can represent a ‘L-block’. For example a sequence of three notes in succession that represent a decrease (i.e. two decreases of the tone height) can represent a ‘S-block’. In combination with differently selected definition of an ‘increase’ more than one, two, three . . . half-tone steps and in combination with plateaus ((i.e. at lest two successive notes of the same tone height), the other three missing blocks can easily be defined. When using pre-analyses of the music and adaptive selection rules a basically uniform distribution of block shapes can be assured. FIG. 3 has been provided to show that the content of a game 26 can directly be related to an external context such as the signal 20 or an external signal source.

FIG. 4 is a further example of an implementation of a music based game action control for an electronic game application. In contrast to the timing control of FIG. 2, more than one timing parameter is used in the example. The gaming idea is very simple and can be summarized by the sentence ‘catch the frogs 36, watch out the lions 38’. Conventionally, such games are based on a random generator to control the movements of the frogs 36 and the lions 38. More sophisticated implementations can also provide ‘escape reactions’ to the movements of the frogs 36 and a ‘hunting fever’ for the movements of the lions 38.

The present invention improves the conventional game by controlling the movements of the frogs 36 and the lions 38 according to a received music signal 30. The playback analyses in this implementation is based one a frequency analysis. The frequencies can be used such that the more low frequencies (e.g. bass guitar, bass drum) are present, the faster the lions are and the more high frequencies (e.g. guitars, strings) are present, the faster the frogs are on the playground 34.

To further increase the difficulty of the present game the frequencies can also be used to control the speed of the player FIG. 40 such that the more mid frequencies are present, the faster the player figure can move. This is possible when the player can only determine the direction but not the speed of his FIG. 40.

A more detailed description of he playback analysis is given in the following FIGS. 5 to 7.

FIG. 5 represents a filter diagram of a filter implementation for the game application of FIG. 4. When applying a filter bank to the playback or line in engine, it is easy to derive several frequency-dependent driver parameters out of the context for driving a content of a game. A simple band division filter with e.g. three frequency bands might be enough for most applications splitting the frequency domain as roughly shown in the figure. The frequency range can be set to start e.g. from the lowest frequency that the mobile terminal is able to produce, and it can go to the highest supported.

The filter diagram shows the signal energy pass-characteristics for each of the selected frequencies. The y-axis relates to the amount of energy that that can pass a filter. The x-axis refers to the frequency spectrum 44. A first filter 46 is tuned to the lower-frequency band, a second filter 48 is tuned to the mid-frequency band and the third filter 50 is tuned to the upper-frequency band.

FIG. 6 is a detailed description of a hard-wired analyzer circuit implementation providing the filter characteristics of FIG. 5. This kind of simple frequency split has commonly been used filters for loudspeakers and musically controlled lights in discos, etc. FIG. 6 shows how a three-band filter bank can be constructed, and how temporal energy is measured from each band. When the energy signals are analyzed from the driver, they can be used e.g. to control e.g. the movements or speed of different types of game elements such as enemies.

FIG. 5 shows a driver signal input 52, and the tree filters 46, 48 and 50 and three energy meters 54. Each of the filter signals represents the signal strength in a defined frequency band. The energy meters determine the signal strengths. In the simplest case the filter can be implemented as Resistor-Capacitor elements and the energy meter as diode. More sophisticated approaches can use e.g. oscillatory circuits and rectifier circuits. Most sophisticated approaches can use DSP (digital signal processing) to determine the actual frequency distributions, which can be especially useful in case that the external signal is provided in digital form. A DSP filter can use e.g. Fourier analysis to provide the filter functionality. A typical output signal 56 of the energy meters 54 is displayed in FIG. 7.

FIG. 7 represents a possible output at one of the channels of the filter circuit of FIG. 6. The y-axis relates to the amount of energy 62 that has been detected in a frequency band. The x-axis refers to the frequency time 64. The signal itself is indicated by the curve 60. The curve comprises an energy peak 66 at a time interval. By constantly following the ‘energy content’ i.e. the amount of energy per time unit of the whole input signal, the application can react to rapid energy changes in the music context signal. A peak 66 can e.g. occur between the songs in the play list, or when a chorus starts. Sudden peaks can be used to cause e.g. the birth of several new enemies e.g. in Pacman™-type (a strategy game) of games, or a sudden earthquake in Giana-Sister™-type (a ‘jump an run’ game) of game. The curve 60 represents the short-term energy flow of one channel in the music context signal and an energy peak 66 during it.

It is also possible to measure the long-term energy of an audio context signal, to enable the application to calm down in silent parts of the driver signal, e.g. in intro and verse of typical songs, and react to the more energetic chorus and solo parts by speeding up etc.

The tempo of an audio file can be measured e.g. using a method of determining e.g. the temporal distances between different extrema of said peak signals 66. By using short-term averaging and self-adapted thresholds a nearly continuous time signal can be created. There may be some other similar technique. When the music context is synthesized from MIDI, the tempo can be tracked directly from the MIDI file. The tempo information can be used e.g. to drive the speed of the game or the enemies. It is also possible to use the speed of background elements in MIDI to animate/control game elements or game components e.g. the background of a game scene like moving grass, trees, waves on an ocean an the like.

When the driver context is synthesized from MIDI, the instrument information is in symbolic form, and thus easily available. Some games could use different types of instruments, such as horns, strings, and percussion, to control the speed and properties of different enemies.

FIG. 8 schematically depicts one implementation of context driven content engine. The context driven content features can be added to applications in different ways. The context driven content engine can be implemented as a synthesizer.

The context driven content features can be integrated into MIDI synthesizer and/or audio player, of a platform or a terminal 70 so that all the applications could apply the same application protocol interface (API) calls to utilize the context driven content.

In this case, the context driven content engine 74 should allow triggering sounds or instruments that are not analyzed as input for context driven content analysis. Triggering can be done using MIDI or some other method. This way e.g. context driven content applications 72 (e.g. games) can launch their sound effects using the same context driven content engine 74.

This implementation enables the synthesizer device to provide not only the background music but also some dedicated channels for context driven content signals for controlling the game execution. This approach can be implemented quite easily to the most synthesizers available.

FIG. 9 schematically depicts another implementation of context driven content engine. It is also possible to implement context driven content engine 74 as an analyzer. The context driven content engine 74 could be an independent application in the platform (terminal) 70, that takes e.g. an audio waveform or a MIDI stream as an input signal and puts out the control parameters. In this case the actual playback is generated outside the context driven content features engine 74, in the picture at the context driven application 72. All the applications 72 of the platform 70 can apply to the same API calls to utilize the context driven content feature.

The context driven content engine 74 can also use an external audio data source (not shown) to generate the context driven content driver signals.

It is also possible to integrate the context driven content engine into an application. The whole context driven content analysis and control mechanism can be integrated into application, such as a game application. This alternative is more or less beneficial for platform independent applications and those using something else than audio as the driver signal.

The idea of context driven content can also be applied to other types of applications than musically controlled games. Scanning user-defined pictures can control the game difficulty levels or the background color of an application can be morphed according to the atmosphere of the background music or a scanned picture.

The context driven content introduces a whole new idea for gaming. Gaming in this context should also refer to any kind of ‘screen saver’ and ‘Tamagochi™’ (an electronic or virtual pet) applications using context driven content feature. The old types of games have static or selectable difficulty level, or some sort of virtual intelligence, whereas in context driven content games the difficulty depends on user-selected driver context (e.g. music). Context driven content games can have default difficulty level characteristics, if no context is selected to be the driver.

Below is a list of different content driver types that would be suitable for context driven content applications. These context types can be used individually (e.g. looped), or as “playlists”, so that several files are used sequentially as drivers:
Sampled audio (WAV, MP3, AAC, etc.)
Synthetic audio (SP-MIDI, General MIDI, XMF, etc.)
Picture files (JPEG, GIF, etc.)
Animations (Flash, GIF, etc.)
Video clips (MPEG, AVI, etc.)
Playlists of any of the above

Audio samples (music, speech, etc.) typically vary in time so they are good driver formats for context driven content applications. Another valuable feature of them is that they can simultaneously be played, enriching the user experience.

In game applications, the controlled elements of the game can include (to name some):
Degree of difficulty (game speed, number of enemies, etc.)
Characters' capabilities (speed, armor, jumping power, etc.)
Characters' outlook
Sudden events (earthquakes, explosions, etc.)
background animation (moving animals objects are moving in the rhythm of the music)

The user benefits form the present invention as once a normal simple game has been played through, the user usually has little interest to try it anymore. The ‘context driven’, ‘event driven’ or ‘music driven’ games being one part of the concept of the present invention, make the games last longer in use, because the player can change another piece of his/her favorite music to play in the background and try again. It may be estimated that the characteristics of a user relating to reaction time and aggression are reflected by his presently preferred music style. Therefore, the game can change its characteristics with the selected music style and therefore can stay attractive for a longer period of time.

The concept of the present invention introduces a brilliant new model for applications (especially for games) that can relatively easily be applied to mobile environment. The player can use user-selected background music or pictures to control the tempo of the game, the number of game enemies, competitors etc. By using the present invention games do not get boring easily, and even very simple and old-fashioned games (e.g. Tetris, Space Invaders, Pacman or Giana Sisters) can give new challenges to players. Players do not say anymore “I solved the final level of the game” but “I solved the final level of the game with Queen's ‘The show must go on’ but with Metallica's ‘Enter Sandman’ it is impossible! ”

The present invention can provide a close interaction of the game with a background music a user knows well, so a player can enjoy the reaction of the game to music he know well and may anticipate the game response of the game. It may also be challenging for a user to find the ‘coolest’ music for a game, which might become a game in itself.

It may be beneficial for the user if he is able to become familiar with the input and make some guesses as to the behavior of the game, which result from certain refrains of music passages.

The present invention also allows it to pre-analyze the music. Games are very timing-sensitive, so if the game can become familiar with the music before it plays, it may be able to benefit from anticipating sudden changes (of the music). Another advantage resulting form pre-analyzing is that for example, the game might queue up the correct animation sequence or sound effect to avoid a delay in loading, begin moving the AI (Artificial Intelligence)—controlled opponents into a new configuration before a sudden action, or even change cameras to another scene for a sub-game based on a recurring theme in the music (depending on the sophistication of the analysis engine).

Another advantage resides in that in case of mobile applications the limited processing and battery resources are not exploited for the music analyzing algorithms. Thus the expected central processing unit (CPU) usage may not be reduced during the game. A straightforward analyzing may affect the game execution, if not enough processing power is left for executing the game.

The game may superimpose its own sound effects on an audio output. A coordinated sound effect/audio output could benefit from an analyzer/synthesizer combination. The sound effects may best be unaffected from the actual game background music to prevent that the game ‘feeling’ is not affected. A user may expect a definitive sound effect sequence following a defined input. It may be a feature to e.g. adapt the volume and especially the tone color of the sound effects to the instantaneous volume or one height of the background music. Such small alternations of the sound effect would reduce the recognizeability of the sound effects and the hearing of the users could benefit from such small alternations. Thus it is more likely that the hearing of a user will not become tired so quickly, enabling a user to play a game longer and more frequent than in the case of a single set of background tunes and unaltered sound effects.

It has already been noted that the present invention also allows it to use context data from nearly arbitrary data sources. It is also possible to generate the context data by applying an automated context data generation algorithm. It is for example possible that musical instructions (i.e. context music) can also be generated automatically by a composing algorithm while playing the game.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for generating game control data for an electronic game dependent from context related data comprising:
accessing context data, and
generating game control data on the basis of said accessed context data.

2. Method according to claim 1, further comprising:
executing a game according to said generated game control data.

3. Method according to claim 1, wherein said accessing context data further comprises processing of context data.

4. Method according to claim 3, wherein said processing of context data is performed in response to actual game data.

5. Method according to claim 1, wherein said context data comprise sensor data.

6. Method according to claim 1, wherein said context data comprise music data.

7. Method according to claim 1, wherein said context data comprise visual data.

8. Method according to claim 1, wherein said context data are used to control the timing of the electronic game.

9. Method according to claim 1, wherein said context data are used to control events in said electronic game.

10. Method according to claim 1, wherein said context data are used to control actions in said electronic game.

11. Computer program product comprising program code stored on a computer readable medium for carrying out the method of claim 1 when said program product is run on a computer or network device.

12. Computer program product comprising program code, downloadable from a server for carrying out the method of claim 1 when said program product is run on a computer or network device.

13. Analyzer module comprising:
an interface connectable to a data source for receiving context data,
an interface connectable to a game execution processor, for outputting game control data, and
a processing unit for generating said game control data in accordance with said received context data.

14. Analyzer module according to claim 13, wherein said analyzer is incorporated in a synthesizer module.

15. Electronic gaming device comprising:
a first processing unit for executing an electronic game,
an interface for connecting to a data source for context data,
a second processing unit for generating game control data on the basis of said context data, said second processing unit being connected to said interface for receiving said context data, said second processing unit being connected to said first processing unit for transferring generated game control data to said first processing unit, and
wherein said first processing unit is adapted for executing an electronic game according to said received game control data.

16. Electronic gaming device according to claim 15, further comprising a storage for storing of context data or game control data.

17. Electronic gaming device according to claim 15, wherein said connection between said first and second processing units is a two-way connection.

18. Electronic gaming device according to claim 15, further comprising at least one sensor connected to said second processing unit.

19. Electronic gaming device according to claim 15, further comprising an interface for accessing music data.

20. Electronic gaming device according to claim 15, further comprising an interface for accessing visual data.

21. Electronic gaming device according to claim 15, further comprising a limiting device connected to said first processing unit for limiting the execution of said electronic game according to said received game control data.

22. Electronic gaming device according to claim 15, wherein said electronic gaming device is a mobile gaming device.

23. Electronic gaming device according to claim 22, wherein said electronic gaming device further comprises a cellular telephone.
